(19) United States
(12) Patent Application Publication
(10) Pub. No.: US 2005/0122649 A1
(43) Pub. Date: Jun. 9, 2005

(54) Remote control system

(75) Inventor: Yoshihiko Yamamoto, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/002,825

(22) Filed: Dec. 2, 2004

(30) Foreign Application Priority Data
Dec. 8, 2003 (JP) 2003-409153
Jan. 26, 2004 (JP) 2004-017079

(51) Int. Cl. H02H 3/00

(52) U.S. Cl. 361/62

(57) ABSTRACT

A remote control system is disclosed in which a television and a DVD each include a memory in which control data has been stored, an output section for outputting control data to a remote control device, and a receiving section for receiving a control signal from the remote control device. The remote control device includes an input section for inputting control data, a memory for storing the control data, operation buttons and a pointing device for selecting a desired operation of the television and the DVD, and a transmitting section for transmitting the control signal corresponding to the selected operation, to the television and the DVD.

### BACKGROUND OF THE INVENTION

1. Field of the Invention

The present invention relates to a remote control system, and more specifically, to a remote control system using a multifunctional remote control device capable of remote-controlling a plurality of electrical appliances.

2. Description of the Related Art

Conventionally, for many kinds of electric appliances such as a television, an audio and the like, respective remote control devices capable of remote-controlling them are included, and hence, each home has a plurality of remote control devices corresponding to respective electrical appliances.

With this being the situation, in recent years, a multifunctional remote control device capable of remote-controlling a plurality of electrical appliances by itself, has been put into use.

This type of remote control device includes a type in which control data for controlling each operation of each electrical appliance is stored in advance, and a type into which control data for each electrical appliance is manually inputted and stored (see, for example, Japanese Unexamined Patent Application Publication No. 9-224290).

However, the former type, i.e., the remote control device having control data stored therein in advance, can remote-control only specified electrical appliances in which control data is stored in advance, and, disadvantageously, cannot adapt to a new electric appliance.

On the other hand, the latter type, i.e., the remote control device into which control data is manually inputted, can indeed adapt to a new electric appliance by inputting control data, but undesirably requires much expense in time and effort to input control data for every electrical appliance.

Regarding such remote control devices, which are included with televisions, audios, air conditioners, and the like, as described above, the methods for operating them have been complicated as these electrical appliances have grown more sophisticated.

Accordingly, instrument manuals for explaining methods for operating an electrical appliance and a remote control device, are included with each electrical appliance and corresponding remote control device. For the electrical appliance having a display screen, such as a television, an electrical appliance has been proposed in which explanation data on the method for operating a remote control device is stored in the television in advance, and in which the explanation for operation is displayed on the display screen. Furthermore, from the viewpoint of improving the operability of a remote control device, a remote control device has been proposed in which explanation data on the method for operating the remote control device is stored in the remote control device in advance, and in which the explanation for operation is displayed on the display screen of the remote control device (see, for example, Japanese Unexamined Patent Application Publication No. 2002-191080).

In recent times, since each home has been provided with lots of remote control devices corresponding to respective electrical appliances, each home has been suffered from confusion. In order to eliminating this inconvenience, as described above, a multifunctional remote control device capable of remote-controlling a plurality of electrical appliances has been developed and put in service.

However, regarding the multifunctional remote control device, in the case where the explanation data on an operating method therefor is stored in advance, the explanation for operation that can be displayed on the display screen of the remote control device has been restricted to the explanation for the operation with respect to a remote control device, corresponding to a specified electrical appliance having the explanation data stored therein in advance, and it has been impossible to display the explanation for the operation with respect to the remote control device of a new electrical appliance.

Also, because of an increased complexity of the operating method for the remote control device, the remote control device of which the explanation data is stored in advance has had to store a large amount of explanation data on the operating method. In particular, the multifunctional remote control device has undesirably required a memory for storing a large amount of explanation data on the remote control device concerning each corresponding electrical appliance.

### SUMMARY OF THE INVENTION

Accordingly, it is an object of the present invention to provide a remote control system using a multifunctional remote control device that saves a user from having to manually input control data on each electrical appliance, and that is capable of adapting to the operation with respect to a new electrical appliance.

It is another object of the present invention to provide a remote control device that, even if no explanation data on the operating method therefor is stored in the remote control device in advance, is capable of improving its operability by allowing an explanation for operation to be identifiable on the display screen of the remote control device, as well as to provide a remote control system having the same.

According to one aspect of the present invention, a remote control system includes a plurality of electrical appliances, and a remote control device capable of remote-controlling the plurality of electrical appliances. Herein, each of the plurality of electrical appliances includes: a memory in which the control data of the control signal corresponding to each operation of each of the electrical appliances has been stored; an output section for outputting the control data to the remote control device; and a receiving section for receiving a control signal from the remote control device. The remote control device includes: an input section for inputting the control data from each of the electrical appliances; a memory for storing the control data; an operation section for selecting a desired operation of each of the electrical appliances; and a transmitting section for transmitting the control signal corresponding to the selected operation, to each of the electrical appliances.

According to another aspect of the present invention, a remote control system includes: a remote control device capable of remote-controlling a plurality of electrical appliances; and a control data storage device in which the control data of the control signal corresponding to each operation of each of the electrical appliances has been stored. Herein, the remote control device includes: an input section for inputting the control data from the control data storage device; a memory for recording the control data; an operation section for selecting a desired operation of each of the electrical appliances; and a transmitting section for transmitting the control signal corresponding to the selected operation, to each of the electrical appliances.

The remote control system according to the present invention preferably has a display section for displaying each operation of each of the electrical appliances, based on the control data inputted to the remote control device.

In the remote control system according to the present invention, the display section is preferably provided to the remote control device.

According to the remote control system of the present invention, inputting control data outputted from each electrical appliance or the control data storage device into the remote control device, allows the remote control device to become a multifunctional remote control device easily adaptable to a plurality of electrical appliances.

According to still another aspect of the present invention, a remote control device capable of remote-controlling an electrical appliance includes: an input section for inputting explanation data for explaining the method for operating the remote control device, from another electrical appliance having communication means through the communication means; and a display section for displaying the inputted explanation data.

According to a further aspect of the present invention, a remote control system includes: an electrical appliance; and a remote control device capable of remote-controlling the electrical appliance. Herein, the electrical appliance includes: a memory in which the explanation data for explaining the method for operating the remote control device has been stored; an output section for outputting the explanation data to the remote control device; and a receiving section for receiving the control signal for requiring the output of the explanation data of the remote control device. The remote control device includes: a transmitting section for transmitting the control signal for requiring the output of the explanation data of the remote control device; an input section for inputting the explanation data from the remote control device; and a display section for displaying the inputted explanation data.

According to the remote control device and the remote control system of the present invention, the explanation for the operation with respect to remote control functions can be displayed on the display section of the remote control device, by inputting the explanation data from another electrical appliance having communication means, or a corresponding electrical appliance.

In the remote control device and the remote control system according to the present invention, it is preferable that the remote control device be a multifunctional remote control device capable of remote-controlling a plurality of electrical appliances.

Furthermore, according to the remote control device and the remote control system of the present invention, even for a new electric appliance of which the explanation data is not stored in advance in a multifunctional remote control device, the explanation for operation can be displayed by inputting the explanation data. This makes it possible to adapt to the new electric appliance.

As described above, the remote control system according to the present invention can save a user from having to manually input control data for every electrical appliance, and allows its remote control device to be easily adaptable to a plurality of electrical appliance. Moreover, since this remote control system allows control data on a new electrical appliance to be inputted into the remote control device, it can cope with a new electrical appliance.

Also, since the remote control device can display, on the display section, each-operation for every electrical appliance, it is not necessary to provide the remote control device with an operation button for every operation of an electrical appliance. This allows the number of operation buttons to be reduced, resulting in the improvement in operability of the remote control device.

Moreover, it is not necessary to store the control data for each electrical appliance into the remote control device in advance when producing a remote control device, but it suffices to store only the control data for an electrical appliance to be remote-controlled. Thus, by virtue of the absence of function unnecessary for an operator of the remote control device, the operability of the remote control device can be even more improved.

According to the remote control device and the remote control system of the present invention, even if no explanation data is stored in the remote control device in advance, the explanation for operation can be identified on the display section of the remote control device, so that the remote control device can be operated while identifying the explanation for the operation with respect to the remote control functions, on the display section. This allows the moving frequency of sight line to be reduced as compared with the case where the remote control device is operated while identifying an instruction manual or the explanation for operation displayed on the display screen of an electrical appliance, and also enables mistakes in pushing an operation button to be reduced, thereby enhancing the operability of the remote control device.

Moreover, even for an electrical appliance without a display screen, the explanation for operation based on explanation data can be displayed on its display section, and even if an instruction manual becomes lost, the explanation for operation can be identified.

### BRIEF DESCRIPTION OF THE DRAWINGS

FIG. 1 is a schematic diagram of a remote control system according to a first embodiment of the present invention;

FIG. 2 is a schematic diagram of display screens in the display section of a remote control device used for the remote control system in FIG. 1;

FIG. 3 is a schematic diagram of a further display screen in the display section of the remote control device used for the remote control system in FIG. 1;

FIG. 4 is a schematic diagram of a remote control system according to a second embodiment of the present invention;

FIG. 5 is a schematic diagram of a remote control system according to another embodiment of the present invention;

FIG. 6 is a schematic diagram of display screens in the display section of a remote control device used for the remote control system in FIG. 5; and

FIG. 7 is a schematic diagram of a remote control device according to another embodiment of the present invention.

### DESCRIPTION OF THE PREFERRED EMBODIMENTS

Hereinafter, embodiments according to the present invention will be described with reference to the accompanying drawings.

### First Embodiment

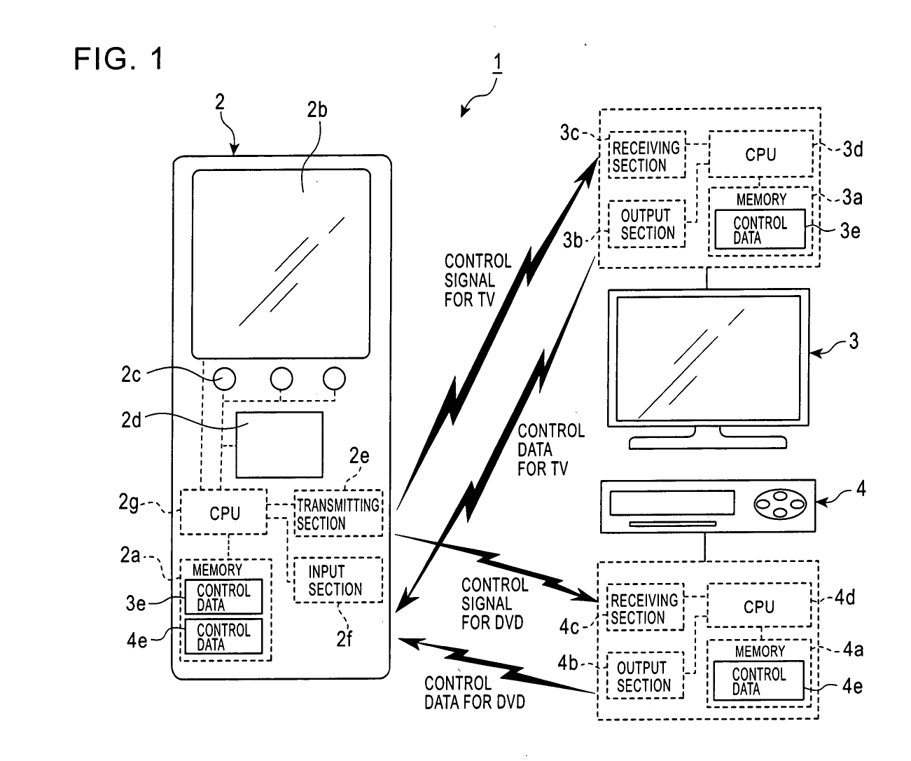

FIG. 1 is a schematic diagram of a remote control system according to a first embodiment of the present invention. As shown in FIG. 1, this remote control system 1 includes a multifunctional remote control device 2 capable of remote-controlling a plurality of electrical appliances, and electrical appliances that are each remote-controlled by a control signal from the remote control device 2. In the first embodiment, a television 3 and a DVD (digital versatile disc) 4 are taken as examples of the electrical appliances.

The television 3 and the DVD 4, respectively, perform operations such as the selection of a channel or the adjustment of a volume level; and a replay or recording, by receiving their respective control signals different for each of the operations.

Memories 3a and 4a each comprising a RAM or the like, of the television 3 and the DVD 4, have control data 3e and 4e stored therein, respectively, in order to output the control data of each control signal to the remote control device 2.

The television 3 and the DVD 4, respectively, include output sections 3b and 4b outputting the control data 3e and 4e to the remote control device 2 using respective infrared (IR) codes, and receiving sections 3c and 4c receiving respective control signals from the remote control device 2.

CPUs (central processing units) 3d and 4d of the television 3 and the DVD 4, respectively, take out the control data 3e and 4e from the memories 3a and 4a, and output them from the output sections 3b and 4b to the remote control device 2. Once the CPUs 3d and 4d, respectively, have received control signals from the remote control device 2, in the receiving sections 3c and 4c, the CPUs 3d and 4d control so that the television 3 and the DVD 4 perform any operations based on the control signals, respectively.

A rewritable memory 2a comprising RAM or the like, of the remote control device 2, stores the control data 3e and 4e inputted from the television 3 and the DVD 4, respectively.

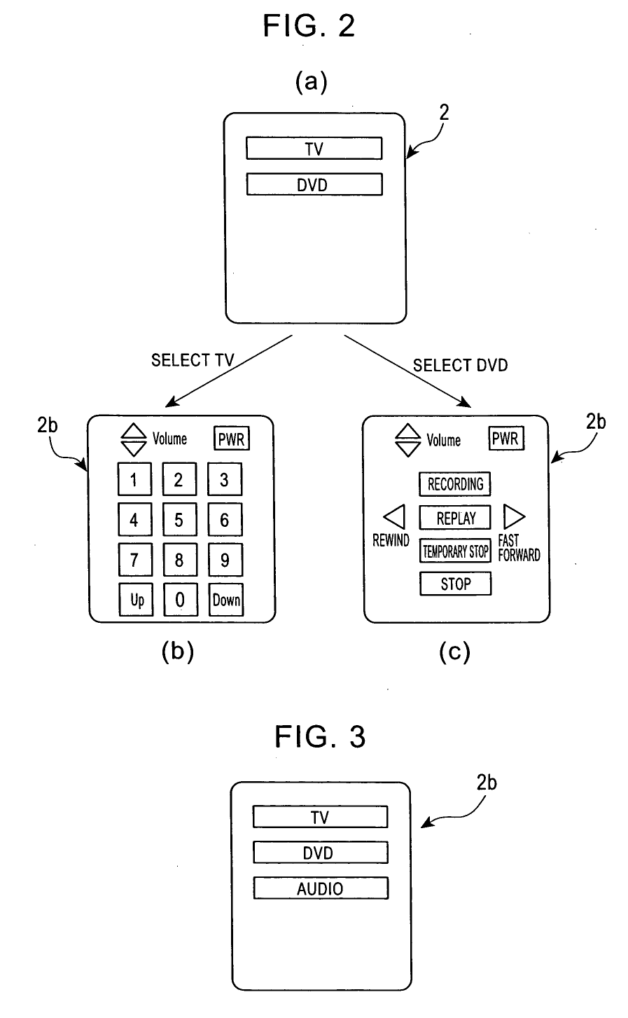

The remote control device 2 has a display section 2b comprising a liquid crystal display device or the like, and displaying the kinds of electrical appliances (in this embodiment, the television 3 and the DVD 4) that have control data 3e and 4e inputted therein, as shown in (a) of FIG. 2, and each operation of each of the television 3 and the DVD 4 based on a respective one of the inputted control data 3e and 4e, as shown in (b) and (c) in FIG. 2.

The remote control device 2 has operation buttons 2c and a pointing device 2d that serve as an operation section for selecting a desired operation of the television 3 or the DVD 4. By the operation button 2c or the pointing device 2d being operated, the remote control device 2 can select each operation of the television 3 or the DVD 4, each operation being displayed on the display section 2b.

Also, the remote control device 2 includes a transmitting section 2e, which transmits the control signal for an operation selected by the operation button 2c or the like to the television 3 or the DVD 4 by wireless communication means such as infrared, radio frequency (RF), or Bluetooth; and an input section 2f, which inputs control data outputted by IR codes from the output sections 3b and 4b of the television 3 and the DVD 4.

Meanwhile, in this embodiment, the output sections 3b and 4b of the television 3 and the DVD 4 output the control data 3e and 4e, respectively, to the remote control device 2 by using respective IR codes, serving as wireless communication means. However, the wireless communication means in this case is not limited to the IR codes. Here, the wireless communication means may include RF, Bluetooth, and the like. Furthermore, the control data 3e and 4e may be outputted to the remote control device 2 by using cable communication means by connecting the output sections 3b and 4b of the television 3 and the DVD 4, with the input section 2f of the remote control device 2 using USB (universal serial bus) cables or the like.

Once the control data 3e or 4e from the television 3 or the DVD 4 has been inputted into the input section 2f, the CPU 2g of the remote control device 2 causes the control data 3e or 4e to be stored in the memory 2a. Also, once each operation of the television 3 or the DVD 4 has been selected by the operation button 2c or the pointing device 2d, the CPU 2g transmits the selected control signal from the transmitting section 2e to the television 3 or the DVD 4.

Next, the operations in this embodiment will be described.

First, a start operation for starting the output of the control data 3e or 4e from the television 3 or the DVD 4 to the remote control device 2, is performed. This start operation may also performed by using the operation button or the like provided to the main body of the television 3 or the DVD 4, or a remote control device (not shown) included with them. Alternatively, the start operation may performed by transmitting the control signal for start operation from the remote control device 2 of the present remote control system 1 to the television 3 or the DVD 4.

Thereupon, the CPU 3d or 4d of the television 3 or the DVD 4 takes out the control data 3e or 4e from the memory 3a or 4a, and outputs the control data 3e or 4e from the output section 3b or 4b to the remote control device 2 by the corresponding wireless communication means.

Next, the CPU 2g of the remote control device 2 inputs the control data 3e or 4e from the television 3 or the DVD 4 into the input section 2f, and stores the control data 3e or 4e into the memory 2a.

Also, as shown in (a) of FIG. 2, the CPU 2g of the remote control device 2 performs a display of the television 3 and the DVD 4 on the display section 2b, in order to make it determinable which is to be remote-controlled out of the television 3 and the DVD 4 in which the control data 3e and 4e have been inputted, respectively.

Next, when performing a remote control of the television 3 using the remote control device 2, once the television 3 has been selected using the pointing device 2d and the operation button 2c in the display in (a) of FIG. 2 on the display section 2b, the display section 2b displays each operation of the television 3 as shown in (b) of FIG. 2 on the display section 2b. An desired operation of the television 3, therefore, is selected on this display using the pointing device 2d and the operation button 2c. Thereupon, the CPU 2g of the remote control device 2 takes out the control signal for the selected operation from the control data 3e of the television 3 stored in the memory 2a, and transmits it from the transmitting section 2e to the television 3. The CPU 3d of the television 3 receives the control signal in the receiving section 3c, and performs the desired operation based on the control signal. Thereby, the remote control of the television 3 can be achieved using the remote control device 2.

On the other hand, when performing a remote control of the DVD 4 using the remote control device 2, once the DVD 4 has been selected using the pointing device 2d and the like in the display in (a) of FIG. 2 on the display section 2b, the display section 2b displays each operation of the DVD 4 as shown in (c) of FIG. 2 on the display section 2b. An desired operation of the television 3, therefore, is selected on this display using the pointing device 2d and the like, and thereby the remote control of the DVD 4 can be achieved using the remote control device 2.

Furthermore, when performing a remote control of an audio device (not shown) as a new electrical appliance, control data for controlling the audio device is outputted from the audio device in which the control data is stored in advance, to the remote control device 2, and this control data is stored into the memory of the remote control device 2. Thereby, as an electrical appliance that is remote-controllable by the remote control device 2, an audio device is newly added to the display in the display section 2b as shown in FIG. 3, thus allowing the remote-control of an audio device to be additionally performed using the remote control device 2.

According to this embodiment, inputting control data 3e and 4e outputted from the television 3 and the DVD 4 into the remote control device 2, enables the remote control device 2 to become a multifunctional remote control device 2 easily adaptable to a plurality of electrical appliances.

Therefore, according to this embodiment, it is possible to save a user from having to manually input control data 3e and 4e for every electrical appliance, and cause the remote control device 2 to easily adapt to a plurality of electrical appliance. Moreover, since the remote control system 1 according to this embodiment allows the remote control device 2 to input control data on a new electrical appliance, it can also cope with a new electrical appliance.

Also, since the remote control device 2 can display, on its display section, each operation for each of the electrical appliances, i.e., the television 3 and the DVD 4, it is not necessary to provide the remote control device 2 with an operation button 2c for every operation of each of the television 3 and the DVD 4. This allows the number of operation buttons to be reduced, leading to the improvement in operability of the remote control device 2.

When producing a remote control device 2, it is not necessary to store the control data of each electrical appliance into the remote control device 2 in advance, but it suffices to store only the control data 3e and 4e for an electrical appliance to be remote-controlled. Thus, by virtue of the absence of function unnecessary for an operator of the remote control device 2, the operability of the remote control device 2 can be even more improved.

### Second Embodiment

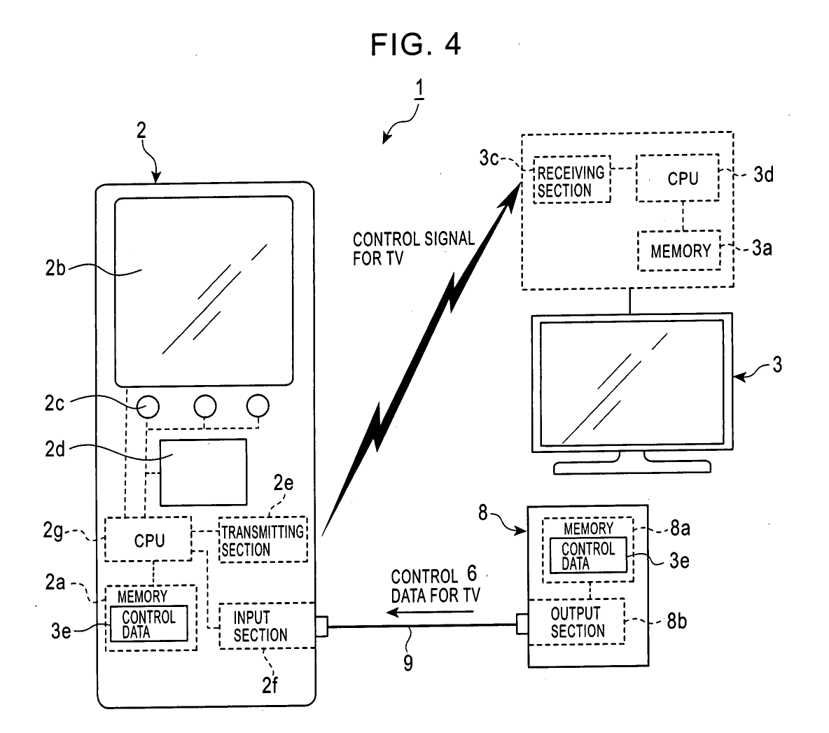

Next, a second embodiment according to the present invention will be described with reference to FIG. 4. In the second embodiment, the same or equivalent components as those in the first embodiment are designated by the same reference numerals.

As shown in FIG. 4, a remote control system 1 according to the second embodiment includes a multifunctional remote control device 2 capable of remote-controlling a plurality of electrical appliances, an electrical appliance (in this embodiment, the television 3) that is remote-controlled by a control signal from the remote control device 2, and a control data storage device 8 in which control data for controlling the television 3 has been stored.

The control data storage device 8 has an output section 8b for outputting control data 6 to the remote control device 2. The output section 8b is connected with the input section 2f of the remote control device 2 by an USB cable 9. In the memory 8a of the control data storage device 8, control data for at least one electrical appliance (in this embodiment, the control data 3e for the television 3) has been stored.

The control data storage device 8 outputs the control data 3e stored in its memory 8a from its output section 8b to the remote control device 2 through a USB cable.

Here, the output section 8b of the control data storage device 8 outputs the control data 3e by cable communication means. However, the communication means in this case is not limited to the cable communication means. Here, the control data 3e may be outputted by wireless communication means, as in the case of the first embodiment. Alternatively, the control data 3e may be outputted by inserting the output section 8b of the control data storage device 8 into the input section 2f of the remote control device 2, that is, by directly connecting them.

Because other constructions of the second embodiment are the same as those of the first embodiment, they are omitted from a detailed description. However, as in the second embodiment, when the control data 3e can be outputted to the remote control device 2 using the control data storage device 8, the television 3 itself corresponding to the control data 3e does not need to store the control data 3e, and does not need to have the output section 3b for outputting the control data 3e.

According to this embodiment, by outputting the control data 3e from the control data storage device 8 to the remote control device 2, the remote control device 2 can perform a remote-control of the television 3 corresponding to the control data 3e.

This can save a user from having to manually input control data 3e for every electrical appliance, and allows the remote control device 2 to be easily adaptable to a plurality of electrical appliance. Moreover, since this remote control system 1 according to this embodiment allows the control data on a new electrical appliance to be inputted into the remote control device 2, it can cope with a new electrical appliance. Furthermore, even if the electrical appliance itself, such as the television 3, has no stored control data, the remote control device 2 allows a remote control of the television 3 to be performed, so that the remote control system 1 enables the remote control device 2 to cope with even more electrical appliances.

The present invention is not restricted to the above-described embodiments, but can be variously changed as required.

The electrical appliances to be used in the remote control system 1 according to the present invention are not limited to the television 3 and the DVD 4 described above, but may include other various electrical appliances such as an audio device, an air conditioner, etc.

Also, in the above-described embodiments, a display section 2b for displaying each operation of the television 3 or the DVD 4 is provided to the remote control device 2, but the method for displaying each operation thereof is not restricted to this method. For example, the method for displaying each operation of the television 3 or the DVD 4 may be such one wherein the display screen of the television 3 or the DVD 4 is utilized as the display section 2b, wherein the above display screen is caused to display thereon each operation of the television 3 or the DVD 4 based on the control data 3e or 4e inputted into the remote control device 2, and wherein each displayed operation is selected by the operation button 2c or the pointing device 2d of the remote control device 2, whereby the control signal of the selected operation can be transmitted from the remote control device 2 to the television 3 or the DVD 4.

### Other Embodiments

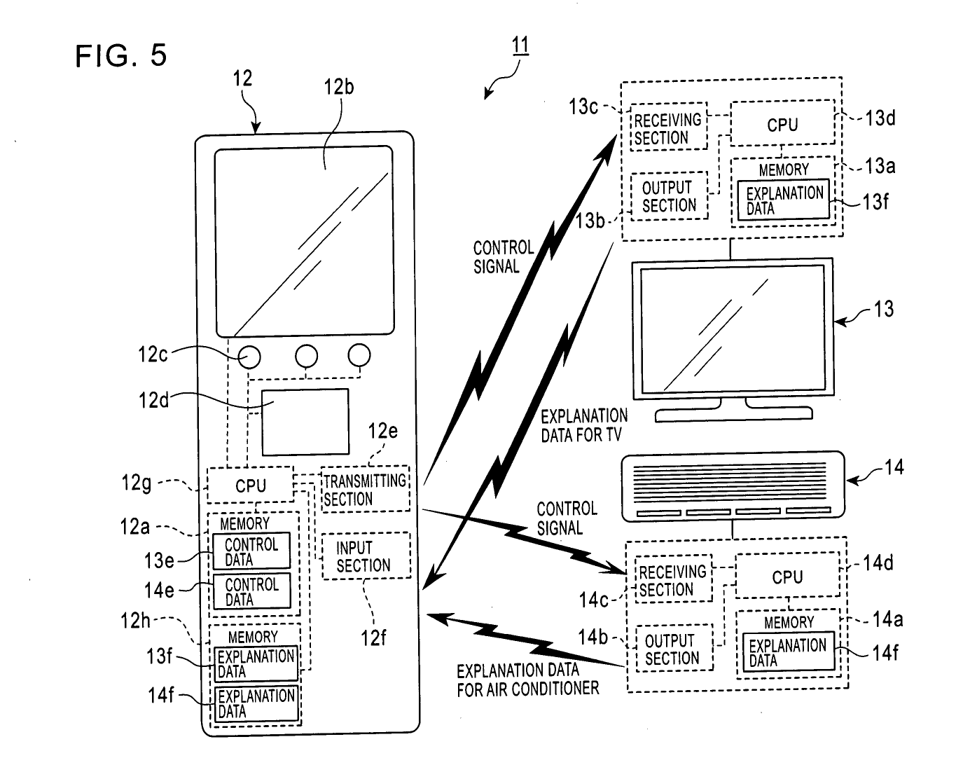

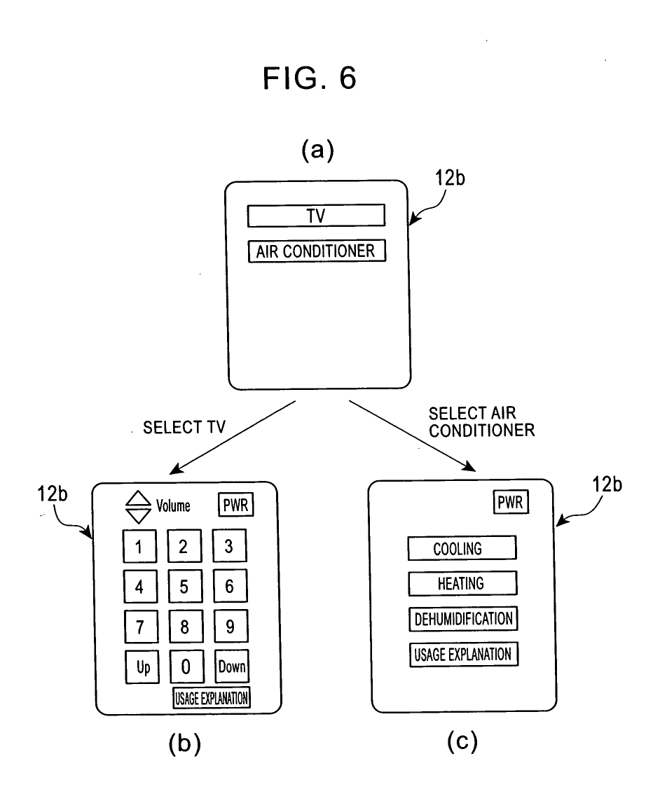

Next, other embodiments according to the present invention will be described with reference to FIGS. 5 and 6.

FIG. 5 is a schematic diagram of a remote control system according to another embodiment of the present invention. As shown in FIG. 5, a remote control system 11 according to this embodiment, includes a multifunctional remote control device 12 capable of remote-controlling a plurality of electrical appliances, and electrical appliances each remote-controlled by a control signal from the remote control device 12. In this embodiment, the television 13 and an air conditioner 14 are taken as examples of electrical appliances.

The television 13 and the air conditioner 14, respectively, perform operations such as the selection of a channel or the adjustment of a volume level; and the selection of function such as cooling, heating, or the like by receiving their respective control signals different for each of the operations.

Stored in advance in memories 13a and 14a of the television 13 and the air conditioner 14, respectively, are explanation data 13f and 14f, which include: (1) explanations for the operations with respect to the television 13 and the air conditioner 14, and (2) explanations for the operations with respect to the remote control functions corresponding to the television 13 and the air conditioner 14, of the remote control device 12 for coping with the television 13 and the air conditioner 14.

The television 13 and the air conditioner 14, respectively, include output sections 13b and 14b outputting the explanation data 13f and 14f to the remote control device 2 using respective IR codes, and receiving sections 13c and 14c for receiving a control signal from the remote control device 12.

CPUs 13d and 14d of the television 13 and the air conditioner 14, respectively, take out the explanation data 13f and 14f from the memories 13a and 14a, and output them from the output sections 13b and 14b to the remote control device 12. Once the CPUs 13d and 14d, respectively, have received control signals from the remote control device 12, in the receiving sections 13c and 14c, the CPUs 13d and 14d control so that the television 13 and the air conditioner 14 perform any operations based on the control signals, respectively.

In the memory 12a of the remote control device 12, the control data 13e and 14e for controlling the television 13 and the air conditioner 14 are stored, respectively. Also, the remote control device 12 has a memory 12h for temporarily storing the explanation data 13f and 14f inputted from the television 13 and the air conditioner 14.

The remote control device 12 has a display section 12b comprising a liquid crystal display device, or the like for displaying the kinds of adaptable electrical appliances having control data 13e and 14e in the remote control device 12 (in this embodiment, the television 13 and the air conditioner 14), and displaying each operation of each of the television 13 and the air conditioner 14 based on a respective one of the control data 13e and 14e. Based on the explanation 13f and 14f inputted from the television 13 and the air conditioner 14, respectively, the display section 12b also displays the explanation for operation with respect to the television 13 and the air conditioner 14, as well as the explanation for operation with respect to the remote control functions corresponding to the television 13 and the air conditioner 14.

The remote control device 12 has operation buttons 12c and a pointing device 12d that serve as an operation section for selecting a desired operation of the television 13 or the air conditioner 14. By the operation button 12c or the pointing device 12d being operated, the remote control device 12 can select each operation of the television 13 or the air conditioner 14, each operation thereof being displayed on the display section 12b. Moreover, by the operation button 12c or the like being operated, the remote control device 12 can perform the operation to require the output of the explanation data 13f and 14f of the television 13 and the air conditioner 14.

The remote control device 12 includes a transmitting section 12e, which transmits the control signal for an operation selected by the operation button 12c or the like to the television 13 or the air conditioner 14 by wireless communication means such as infrared, RF, or Bluetooth; and an input section 12f, which inputs explanation data 13f and 14f outputted using IR codes from the output sections 13b and 14b of the television 13 and the air conditioner 14.

In this embodiment, the output sections 13b and 4b of the television 13 and the air conditioner 14, respectively, output the explanation data 13f and 14f to the remote control device 12 by using IR codes, serving as wireless communication means. However, the wireless communication means in this case is not limited to the IR codes. Here, the wireless communication means may include RF, Bluetooth, and the like. Furthermore, the explanation data 13f and 14f may be outputted to the remote control device 12 by using cable communication means by connecting the output sections 13b and 14b of the television 13 and the air conditioner 14, with the input section 12f of the remote control device 12 using USB cables or the like.

Once the explanation data 13f or 14f from the television 3 or the air conditioner 14 has been inputted into the input section 12f, the CPU 12g of the remote control device 12 causes the explanation data 13f or 14f to be stored in the memory 12h on a temporary basis or a continuous basis.

Also, once each operation of the television 13 or the air conditioner 14 has been selected by the operation button 12c or the pointing device 12d, the CPU 12g of the remote control device 12 transmits the control signal for the selected operation from the transmitting section 12e to the television 13 or the air conditioner 14, and transmits also the control signal for requiring the output of the explanation data 13f or 14f from the transmitting section 12e to the television 13 or the air conditioner 14.

Now, the operations in this embodiment will be described.

When attempting to cause the display section 12b of the remote control device 12 to display the explanation for usage of the remote control functions corresponding to the television 13 or the air conditioner 14, on the display section 12b of the remote control device 12, firstly the operation for requiring the output of the explanation data 13f or 14f is performed by the operation button 12c or the pointing device 12d of the remote control device 12.

For example, using the operation button 12c or the like, the selection is made as to which explanation for usage is to be displayed, out of the explanations for usage of television 13 and the air conditioner, controllable by the remote control device 12 and displayed on the display section 12b as shown in (a) of FIG. 6. Then, with respect to the display of each operation of the television 13 as shown in (b) of FIG. 6, or the display of each operation of the air conditioner 14 as shown in (c) of FIG. 6, the operation for causing the display section 12b to display the explanation for usage is selected using the operation button 12c or the like.

Thereupon, the CPU 12g of the remote control device 12 transmits the control signal for requiring the output of the explanation data 13f or 14f, from the transmitting section 12e to the television 13 or the air conditioner 14.

Then, once the CPU 13d or 14d of the television 13 or the air conditioner 14 has received the control signal for requiring the output of the explanation data 13f or 14f, in the receiving section 13c or 14c, the CPU 13d or 14d takes out the explanation data 13f or 14f from the memory 13a or 14a, and outputs the explanation data 13f or 14f from the output section 13b or 14b to the remote control device 12 by the corresponding wireless communication means.

Furthermore, the CPU 12g of the remote control device 12 inputs the explanation data 13f or 14f outputted from the television 13 or the air conditioner 14, in the input section 12f, and stores the explanation data 13f or 14f into the memory 12h.

The CPU 12g of the remote control device 12 takes out the explanation data 13f or 14f from the memory 12h, and displays, on the display section 12b, the explanation for the operation with respect to the television 13 or the air conditioner 14 based on the explanation data 13f or 14f.

According to this embodiment, by inputting the explanation data 13f and 14f stored in the television 13 and the air conditioner 14, into the remote control device 12, the explanations for the operations with respect to the television 13 and the air conditioner 14, and that with respect to remote the control functions corresponding to the television 13 and the air conditioner 14 can be displayed on the display section 12b of the remote control device 12.

Therefore, even if the explanation data 13f or 14f is not stored in advance in the remote control device 12, the corresponding explanation for operation can be identified on the display section 12b of the remote control device 12.

Also, it is possible to cause the display section 12b of the remote control device 12 to display the explanation for operation, and to operate the remote control device 12 while identifying the explanation for the operation with respect to the remote control functions, on the display section 12b. This makes it possible to reduce the moving frequency of sight line to be reduced as compared with the case where the remote control device 12 is operated while identifying an instruction manual, or the explanation for operation displayed on the display screen of the television 13 or the like. Furthermore, this reduces mistakes in pushing the operation button 12c, thereby enhancing the operability of the remote control device 12.

Moreover, even for an electrical appliance such as the air conditioner 14 without a display screen, the explanation for operation based on the explanation data 14f can be displayed on the display section 12b, and even if an instruction manual becomes lost, the explanation for operation can be identified.

The present invention is not restricted to the above-described embodiments, but can be variously changed as required.

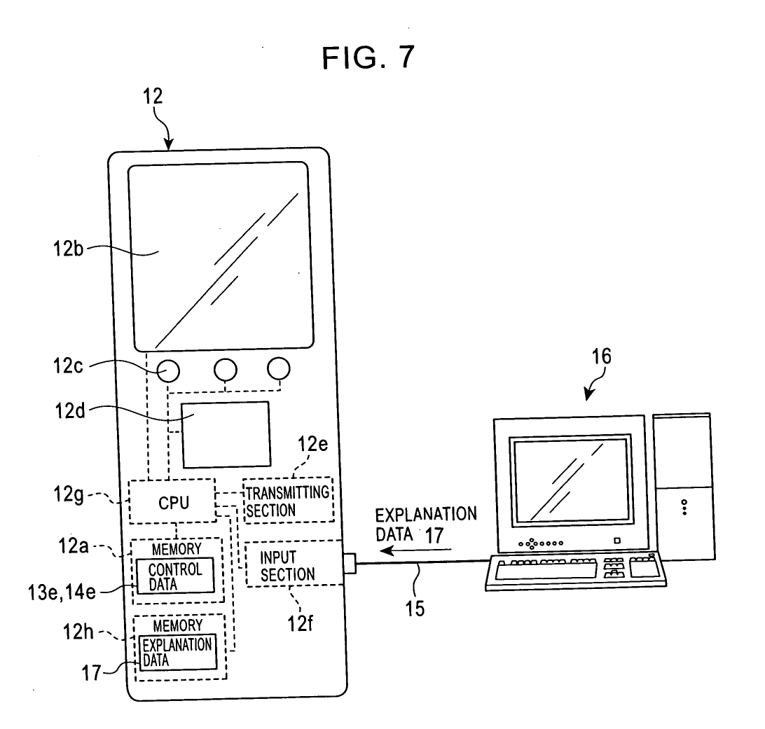

Although, as an example of the remote control device 12, a type in which the explanation data 13f and 14f are to be inputted from the corresponding electrical appliance has been taken, the remote control device 12 is not limited to this type. The remote control device 12 may include a type that is connectable to a personal computer 16 through a USB cable 15 or the like as shown in FIG. 7, that inputs necessary explanation data 17 on the remote control functions downloaded from the Internet, into the input section 12f, that stores the explanation data 17 into the memory 12h, and that displays the explanation for operation based on the explanation data 17, on the display section 12b.

1. A remote control system comprising:
a plurality of electrical appliances; and
a remote control device capable of remote-controlling the plurality of electrical appliances,
wherein each of the plurality of electrical appliances includes:
a memory in which control data of a control signal corresponding to each operation of each of the electrical appliances has been stored;
an output section for outputting the control data to the remote control device; and
a receiving section for receiving a control signal from the remote control device, and
wherein the remote control device includes:
an input section for inputting control data from each of the electrical appliances;
a memory for storing the control data;
an operation section for selecting a desired operation of each of the electrical appliances; and
a transmitting section for transmitting the control signal corresponding to the selected operation, to each of the electrical appliances.

2. A remote control system comprising:
a remote control device capable of remote-controlling a plurality of electrical appliances; and
a control data storage device in which control data of a control signal corresponding to each operation of each of the electrical appliances has been stored,
wherein the remote control device includes:
an input section for inputting control data from the control data storage device;
a memory for recording the control data;
an operation section for selecting a desired operation of each of the electrical appliances; and
a transmitting section for transmitting the control signal corresponding to the selected operation, to each of the electrical appliances.

3. The remote control system according to claim 1, further comprising a display section for displaying each operation of each of the electrical appliances, based on the control data inputted into the remote control device.

4. The remote control system according to claim 3, wherein the display section is provided to the remote control device.

5. A remote control device capable of remote-controlling an electrical appliance, the device comprising:
an input section for inputting explanation data for explaining a method for operating the remote control device, from another electrical appliance having communication means, through the communication means; and
a display section for displaying the inputted explanation data.

6. The remote control device according to claim 5, wherein the remote control device is a multifunctional remote control device capable of remote-controlling a plurality of electrical appliances.

7. A remote control system comprising:
an electrical appliance; and
a remote control device capable of remote-controlling the electrical appliance,
wherein the electrical appliance includes:
a memory in which the explanation data for explaining a method for operating the remote control device has been stored;
an output section for outputting the explanation data to the remote control device; and
a receiving section for receiving a control signal for requiring the output of the explanation data from the remote control device, an
wherein the remote control device includes:
a transmitting section for transmitting the control signal for requiring the output of the explanation data of the remote control device;
an input section for inputting the explanation data from the remote control device; and
a display section for displaying the inputted explanation data.

8. The remote control system according to claim 7, wherein the remote control device is a multifunctional remote control device capable of remote-controlling a plurality of electrical appliances.
